(19) United States
(12) Patent Application Publication
(10) Pub. No.: US 2025/0131315 A1
(43) Pub. Date: Apr. 24, 2025

(54) QUANTUM COMPUTER VERIFICATION APPARATUS AND METHOD

(71) Applicant: NIPPON TELEGRAPH AND TELEPHONE CORPORATION, Tokyo (JP)

(72) Inventors: Yuki TAKEUCHI, Tokyo (JP); Seiichiro TANI, Tokyo (JP); Yasuhiro TAKAHASHI, Tokyo (JP)

(73) Assignee: NIPPON TELEGRAPH AND TELEPHONE CORPORATION, Tokyo (JP)

(21) Appl. No.: 18/696,054

(22) PCT Filed: Oct. 20, 2021
(86) PCT No.: PCT/JP2021/038778

§ 371 Date: Mar. 27, 2024

(51) Int. Cl. G06N 10/70; G06N 10/20

(52) U.S. Cl. CPC G06N 10/70; G06N 10/20

(57) ABSTRACT

A quantum computer verification apparatus includes: a division unit 1 that divides n qubits on which a quantum circuit U acts into m qubits and (n−m) qubits such that the number of CZ gates across the qubits becomes D=O(log n); a stabilizer operator calculation unit 2 that calculates a stabilizer operator \hat{ }sₖ for each k; an estimation unit 3 that randomly selects (i, j, i′, j′) T₂ times for each k and calculates estimates of a real part of a value of the following expression to obtain T₂ estimates;

$${( - 1 )}^{i \cdot j + {i}^{′} \cdot {j}^{′}} T r [ {ρ}_{out} [ {Q}_{i , j}^{†} ( {\prod }_{i = 1}^{n} {Z}_{i}^{{k}_{i}} ) {Q}_{{i}^{′} , {j}^{′}} ] ]$$

an average calculation unit 4 that obtains an average of the T₂ estimate for each k and sets the obtained average as an estimate of Tr[ρₒᵤₜ\hat{ }sₖ] corresponding to each k, and a fidelity estimation value calculation unit 5 that obtains an average of estimates of Tr[ρₒᵤₜ\hat{ }sₖ] corresponding to each k.

### TECHNICAL FIELD

The present invention relates to a technique for verifying correctness of operation of a quantum computer.

### BACKGROUND ART

A quantum computer having a size n is a computer that obtains a calculation result by preparing n qubits represented by a normalized two-dimensional complex vector, causing one arbitrary qubit gate and CZ gate to act on the qubits, and finally measuring some or all of the qubits with a Pauli Z basis also called a calculation basis.

In particular, in a case where a quantum computer is realized in a solid quantum system such as a superconducting circuit, an operation is performed on qubits prepared on a chip.

Such a chip is referred to as a quantum chip and is characterized by a graph representing qubits between which a 2-qubit gate can directly act. Each vertex of the graph represents the position of a qubit, which represents that a 2-qubit gate can directly act only between qubits connected by a side.

As a specific example, a graph characterizing a quantum chip with 53 qubits (refer to Non Patent Literature 1, for example) created by IBM Corporation is illustrated in FIG. 6. Numbers 0 to 52 are numbers of qubits, which represents that a 2-qubit gate can be directly applied between the 0th and the 1st, but cannot be directly applied between the 0th and the 2nd, for example.

In particular, by removing a constant number of sides independent of the value of n from a graph characterizing a quantum chip including n qubits, the graph can be separated into two partial graphs having O(n) vertices, and the quantum chip is said to be sparse.

In the case of FIG. 6, as indicated by a broken line, by removing two of the side between the 21st and 28th vertices and the side between the 25th and 29th vertices, it is possible to separate the graph into a partial graph including the 0th to 27th vertices and a partial graph including the 28th to 52nd vertices.

Verification of a quantum computer involves estimating how close a state ρₒᵤₜ generated by repeating 1 and 2-qubit gates for qubits on an actually created quantum chip is to an ideal pure state |Ψₜ> expected from the theory. Specifically, the purpose of verification is to obtain a real number Fₑₛₜ satisfying |F−Fₑₛₜ|≤ε a with a probability of 1-δ or more for fidelity F=<Ψₜ|ρₒᵤₜ|Ψₜ>, which is a quantity representing closeness.

Here, ρₒᵤₜ is a 2ⁿ×2ⁿ semidefinite matrix with a trace value of 1, |Ψₜ> is a 2ⁿ-dimensional normalized complex vector, <Ψₜ| is conjugate transposition of |Ψₜ>, and ε and δ are real numbers satisfying 0<ε and δ<1.

As ε is closer to 0, it means that an actual fidelity and an obtained estimate are closer, and thus estimation accuracy is higher. In addition, as δ is closer to 0, an estimation failure probability decreases, and thus estimation with high reliability can be performed.

Usually, the size of a quantum device (referred to as B for clarity) available to obtain Fₑₛₜ is required to be less than the size of a quantum computer (referred to as A for clarity) to be verified. The efficiency of a verification method can be evaluated depending on how many copies of ρₒᵤₜ are input to such a small-scale quantum device B to obtain Fₑₛₜ. Since copies of ρₒᵤₜ are prepared by operating the quantum computer A to be verified as many times as a necessary number of copies, it can be said that the smaller the necessary number of copies is, the more efficient the verification method is. In particular, in a case where a required number of samples is a polynomial with respect to the size n of the quantum computer A to be verified, it is called efficient.

A method is known in which verification can be performed with a number of copies, which is less than or equal to

$$O ( \frac{1}{{ϵ}^{2} δ} + \frac{{2}^{n}}{{ϵ}^{2}} log \frac{1}{δ} ) \qquad [ Math . 1 ]$$

on average if the size of the quantum computer is denoted by n (refer to Non Patent Literature 2, for example). This method is highly versatile and can be used even when the quantum chip is not sparse.

First, for a natural number k satisfying 1≤k≤4ⁿ, Wₖ is set as n tensor products of a Pauli matrix.

$${χ}_{{p}_{out}} ( k ) ≡ Tr [ \frac{{ρ}_{o u t} {W}_{k}}{\sqrt{{2}^{n}}} ] \qquad [ Math . 2 ]$$

is defined using this Wₖ. Using this definition, the fidelity F is written as the following expression.

$$F = {\sum }_{k = 1}^{{4}^{n}} {{χ}_{{ρ}_{out}} ( k )}_{{χ}_{\vert {ψ}_{t} 〉 〈 {ψ}_{t} \vert}} ( k ) \qquad [ Math . 3 ]$$

A procedure performed to estimate F is as follows.

1. First, the value of k is randomly selected according to the following probability distribution expressed as the following expression.

$${\{ {{χ}_{\vert {ψ}_{t} 〉 〈 {ψ}_{t} \vert} ( k )}^{2} \}}_{k = 1}^{{4}^{n}} \qquad [ Math . 4 ]$$

This is repeated L times, and the i-th selected k is written as kᵢ. Here, 1≤i≤L.

2. ρₒᵤₜ is output mᵢ times from the quantum computer, and each is measured with the basis of Wₖᵢ corresponding to the selected value of kᵢ. As a result, Aᵢⱼ∈{1, −1}(1≤j≤mᵢ) is obtained as a j-th measurement result.

By using this result, the value of

$${\tilde{X}}_{i} = \frac{{\sum }_{j = 1}^{n {ι}_{i}} {A}_{ij}}{{m}_{i} \sqrt{{2}^{n}} {χ}_{\vert {ψ}_{t} 〉 〈 {ψ}_{t} \vert} ( {k}_{i} )} \qquad [ Math . 5 ]$$

is calculated. This operation is performed for all i.

3. The average

$$\frac{{\sum }_{i = 1}^{L} {\tilde{X}}_{i}}{L} \qquad [ Math . 6 ]$$

is calculated using {˜Xᵢ}ᵢ₌₁_{^{L}} obtained in step 2, and this is accepted as the estimate Fₑₛₜ of the fidelity F.

Since the value of k is selected according to the probability distribution expressed as the following expression,

$${\{ {{χ}_{\vert {ψ}_{t} 〉 〈 {ψ}_{t} \vert} ( k )}^{2} \}}_{k = 1}^{{4}^{n}} \qquad [ Math . 7 ]$$

the average

$$( {\sum }_{i = 1}^{L} {\tilde{X}}_{i} ) / L \qquad [ Math . 8 ]$$

converges as expressed by the following expression.

$${\sum }_{k = 1}^{{4}^{n}} {{χ}_{\vert {ψ}_{t} 〉 〈 {ψ}_{t} \vert} ( k )}^{2} \frac{Tr [ {ρ}_{o u t} {W}_{k} ]}{\sqrt{{2}^{n}} {χ}_{\vert {ψ}_{t} 〉 〈 {ψ}_{t} \vert} ( k )} = {\sum }_{k = 1}^{{4}^{n}} {χ}_{{ρ}_{out}} ( k ) {χ}_{\vert {ψ}_{t} 〉 〈 {ψ}_{t} \vert} ( k ) = F \qquad [ Math . 9 ]$$

Therefore, if

$$L = ⌈ \frac{8}{{ϵ}^{2} δ} ⌉ , {m}_{i} = ⌈ \frac{8 log 4 / δ}{{2}^{n} {{χ}_{\vert {ψ}_{t} 〉 〈 {ψ}_{t} \vert} ( {k}_{i} )}^{2} L {ϵ}^{2}} ⌉ \qquad [ Math . 10 ]$$

is established using a ceiling function,

$$Pr [ \vert {F}_{est} - F \vert \geq ϵ ] \leq δ \qquad [ Math . 11 ]$$

is derived according to Chebyshev's inequality and Heading's inequality. In the above-described method, Σᵢ₌₁_{^{L}}mᵢ copies are used in total, and the average value thereof becomes

$${\sum }_{i = 1}^{L} [ {\sum }_{{k}_{i}} {{χ}_{\vert {ψ}_{t} 〉 〈 {ψ}_{t} \vert} ( {k}_{i} )}^{2} {m}_{i} ] \leq {\sum }_{i = 1}^{L} [ 1 + \frac{{2}^{n + 3} log ( 4 / δ )}{L {ϵ}^{2}} ] \leq 1 + \frac{8}{{ϵ}^{2} δ} + \frac{{2}^{n + 3}}{{ϵ}^{2}} log \frac{4}{δ} \qquad [ Math . 12 ]$$

at most.

### CITATION LIST

### Non Patent Literature

Non Patent Literature 1: A. Kondratyev, Non-Differentiable Learning of Quantum Circuit Born Machine with Genetic Algorithm, SSRN 3569226, 2020
Non Patent Literature 2: S. T. Flammia and Y.-K. Liu, Direct Fidelity Estimation from Few Pauli Measurements, Phys. Rev. Lett. 106, 230501, 2011

### SUMMARY OF INVENTION

### Technical Problem

Although the method proposed in Non Patent Literature 2 can be applied to verification of any quantum chip including n qubits, a number of copies, which is expressed as the following expression,

$$O ( \frac{1}{{ϵ}^{2} δ} + \frac{{2}^{n}}{{ϵ}^{2}} log \frac{1}{δ} ) \qquad [ Math . 13 ]$$

on average at most is required to perform the verification, and the number of copies increases exponentially with respect to n. In order for a quantum computer to exhibit practical superiority over a classical computer, n needs to be sufficiently large, but with such large n, it takes a huge amount of time to verify the quantum computer. Therefore, even if calculation itself can be performed at a high speed, it takes an exponentially long time to confirm whether the calculation is performed correctly, and the high speed in calculation is canceled by the time taken for verification. In particular, it is important to verify whether or not a correct quantum state can be output because small and medium-scale quantum computers currently being realized do not have an error correction function.

An object of the present invention is to provide a quantum computer verification apparatus and a quantum computer verification method capable of verifying a quantum computer more efficiently than before.

### Solution to Problem

A quantum computer verification apparatus according to one aspect of the present invention includes: a division unit configured to divide n qubits on which a quantum circuit U acts into m qubits and (n−m) qubits such that the number of CZ gates across the qubits becomes D=O(log n), the quantum circuit U being able to be expressed by the following expression using an m-qubit gate Vᵢ and an (n−m)−qubit gate Wⱼ;

$$U = \frac{1}{{2}^{D}} {\sum }_{i , j ∈ D , {1}^{D}} {( - 1 )}^{i , j} {V}_{i} ⊗ {W}_{j} \qquad [ Math . 14 ]$$

a stabilizer operator calculation unit configured to randomly select a value of k∈{0, 1}ₙ T₁ times, and calculate a stabilizer operator \hat{ }sₖ defined by the following equation for each k, where Q_{i,j}^{†}=Vᵢ(×)Wⱼ, kᵢ is an i-th bit of k, Zᵢ is a Pauli Z gate acting on an i-th qubit, i_{L} and j_{L} are L-th bits of i and j, i·j=(+)_{L=1}_{^{D}}i_{L}j_{L}, and T₁ is a predetermined positive integer;

$$\text{?} \qquad [ Math . 15 ]$$

$$\text{?} \text{indicates text missing or illegible when filed}$$

an estimation unit configured to randomly select (i, j, i′, j′) T₂ times for each k and calculate estimates of a real part of a value of the following equation to obtain T₂ estimates, where ρₒᵤₜ is a state output by the quantum circuit U;

$${( - 1 )}^{i \cdot j + {i}^{′} \cdot {j}^{′}} Tr [ {ρ}_{out} [ {Q}_{i , j}^{+} ( {\prod }_{i = 1}^{n} {z}_{i}^{{k}_{i}} ) {Q}_{{i}^{′} , {j}^{′}} ] ] \qquad [ Math . 16 ]$$

an average calculation unit configured to obtain an average of the T₂ estimates for each k and set the obtained average as an estimate of Tr[ρₒᵤₜ\hat{ }sₖ] corresponding to each k; and a fidelity estimation value calculation unit configured to obtain an average of estimates of Tr[ρₒᵤₜ\hat{ }sₖ] corresponding to each k and set the average as an estimate Fₑₛₜ of fidelity F of the quantum circuit U.

### Advantageous Effects of Invention

It is possible to verify a quantum computer more efficiently than before.

### BRIEF DESCRIPTION OF DRAWINGS

FIG. 1 is a diagram illustrating an example of a functional configuration of a quantum computer verification apparatus.

FIG. 2 is a diagram illustrating an example of a processing procedure of a quantum computer verification method.

FIG. 3 is a diagram for describing a density of a quantum state.

FIG. 4 is a diagram for describing processing of an estimation unit 3.

FIG. 5 is a diagram illustrating an overview of an operation of an embodiment.

FIG. 6 is a diagram illustrating an example of a graph showing a quantum chip.

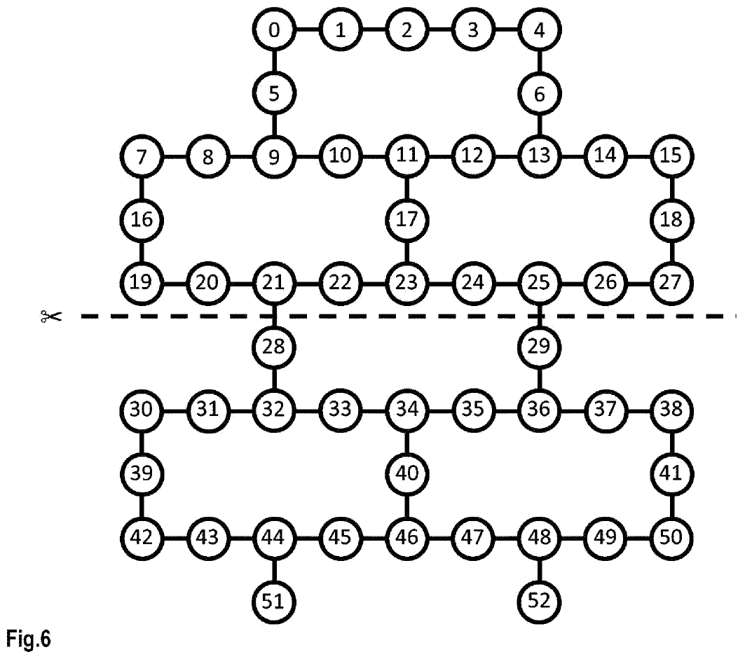

### DESCRIPTION OF EMBODIMENTS

Hereinafter, an embodiment of the present invention will be described in detail. In the drawings, components having the same functions are denoted by the same reference numerals, and redundant description will be omitted.

### [Quantum Computer Verification Apparatus and Method]

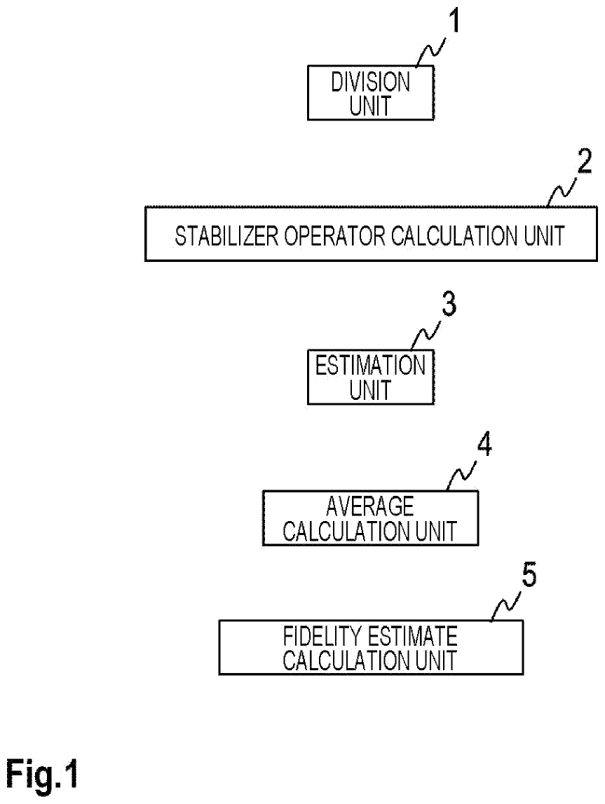

As illustrated in FIG. 1, a quantum computer verification apparatus includes, for example, a division unit 1, a stabilizer operator calculation unit 2, an estimation unit 3, an average calculation unit 4, and a fidelity estimation value calculation unit 5.

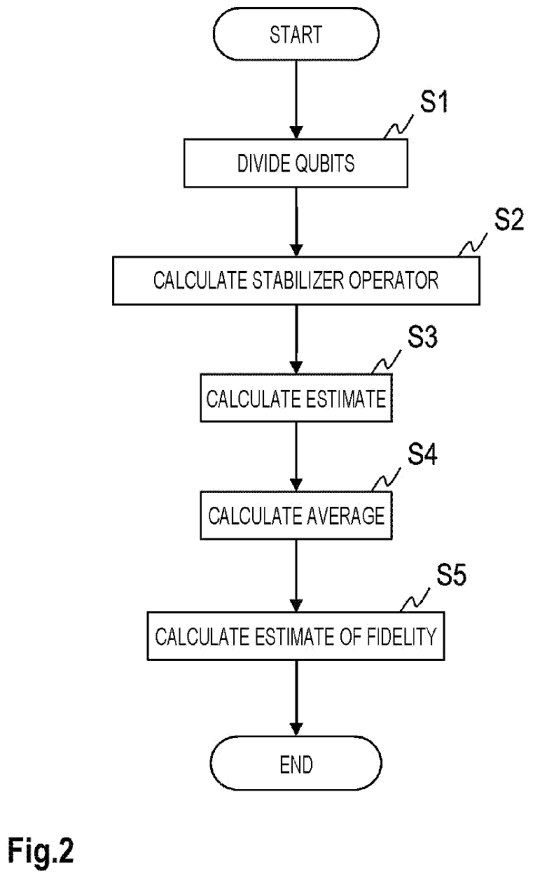

A quantum computer verification method is realized by each component of the quantum computer verification apparatus performing processing of steps S1 to S5 described below and illustrated in FIG. 2.

Note that the symbol “\hat{ }” used in the text would normally be written immediately above the immediately following character, but is written immediately before the character due to limitations of text notation. In mathematical expressions, these symbols are described at their normal positions, that is, directly above the characters. For example, “^{\hat{ }}X” in the text is written as follows in a mathematical expression.

$$\hat{X} \qquad [ Math . 17 ]$$

The quantum computer verification apparatus and the quantum computer verification method are an apparatus and a method for performing verification of a quantum computer more efficiently than before. Verification involves evaluating closeness between an actually output quantum state and a theoretically expected correct quantum state as a quantity called fidelity.

In the following, a method of estimating fidelity by measuring a number of copies, which is expressed as the following expression,

$$O ( \frac{{2}^{12 D}}{{ϵ}^{6}} {( D + log \frac{1}{{δϵ}^{4}} )}^{3} ) \qquad [ Math . 18 ]$$

through a number of qubits, which is less than n, for an n-qubit state with a density D is proposed. This method can also be applied to a general quantum computer similarly to the conventional method. This method is particularly efficient in a case where it is used for verification of a quantum computer in which the density of an output quantum state is D=O(log n). As described later, this method can also be used for verification of a quantum computer in which D≠O(log n).

The density of a quantum state is defined as follows. A gate set including single-qubit gates and controlled-Z (CZ) gates is conceived.

$$CZ ≡ ( \begin{matrix}1 & 0 & 0 & 0 \\ 0 & 1 & 0 & 0 \\ 0 & 0 & 1 & 0 \\ 0 & 0 & 0 & - 1\end{matrix} ) \qquad [ Math . 19 ]$$

An n-qubit circuit configured by combining polynomial gates selected from the gate set is denoted by U. The n-qubit circuit U is abbreviated as a quantum circuit U. If the qubits are divided into two sets A and B having a size O(n), the number of gates across A and B in the quantum circuit U is defined as CUT(A:B). The density D of a quantum state |Ψ>=U|Oⁿ> is a minimum value of CUT(A:B) in all the divisions A:B. Here, |0ⁿ> is n tensor products of |0>=(1,0)^{T}.

A quantum circuit with a depth of O(log n) on a quantum chip represented by a graph that can be divided into two partial graphs having the same number of vertices by removing a constant number of sides is defined as a noisy intermediate-scale quantum (NISQ) computer. Therefore, the density of an output state of the NISQ computer is D=O(log n).

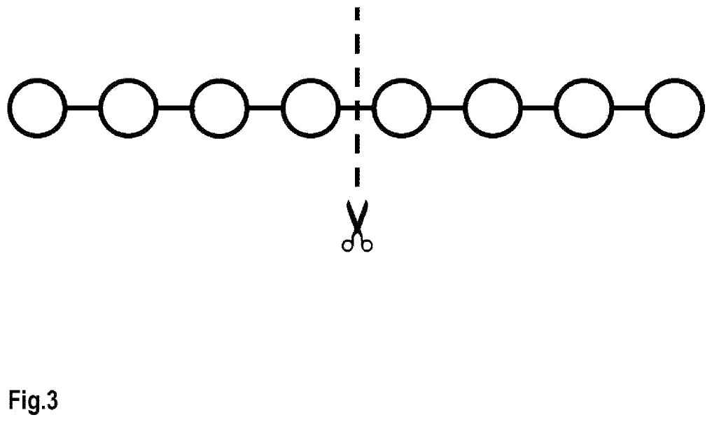

For example, a quantum chip that can be represented by a one-dimensional graph as illustrated in FIG. 3 is conceived. This graph can be divided into two partial graphs having the same number of vertices by removing the middle side. In a case where a quantum circuit having a depth d is mounted on the quantum chip represented by this graph, the density D is at most d.

Fₑₛₜ satisfying |Fₑₛₜ−<Ψₜ|ρₒᵤₜ|Ψₜ≥ε is efficiently obtained with a probability of at least 1−δ for desired 0<ε and δ<1 and any n-qubit state |Ψₜ>=U|0ⁿ> with a density D=O(log n). Here, ρₒᵤₜ is an actual output state of the NISQ computer, and it is assumed that this state does not change with time. Furthermore, it is assumed that any (m+1) qubit gates can be realized with an error of a diamond norm ε/4^{D+2} for n/2≤m<n−1.

First, the division unit 1 divides the n qubits on which the quantum circuit U acts into m qubits and (n−m) qubits such that the number of CZ gates across the qubits becomes D=O(log n) (step S1). Since the density of |Ψₜ> is D=O(log n), such a division can necessarily be performed.

The divided quantum circuit U is represented as follows.

$$U = \frac{1}{{2}^{D}} {\sum }_{i , j ∈ 0 , {1}^{D}} {( - 1 )}^{i \cdot j} {V}_{i} ⊗ {W}_{j} \qquad [ Math . 20 ]$$

For any i and j, Vᵢ and Wⱼ respectively represent an m-qubit gate and an (n−m)-qubit gate.

The stabilizer operator calculation unit 2 randomly selects a value of k∈{0, 1}ⁿ T₁ times and calculates a stabilizer operator \hat{ }sₖ defined by the following expression for each k (step S2). The stabilizer operator calculation unit 2 selects a value of k∈{0, 1}ⁿ, for example, uniformly randomly, T₁ times.

$$\text{?} = \frac{1}{{4}^{D}} \text{?} [ {Q}_{i , j}^{+} ( {\prod }_{i = 1}^{n} {z}_{i}^{{k}_{i}} ) {Q}_{{i}^{′} , {j}^{′}} ] \qquad [ Math . 21 ]$$

$$\text{?} \text{indicates text missing or illegible when filed}$$

T₁ is a predetermined positive integer. Q_{i,j}^{†}=Vᵢ(×)Wⱼ, kᵢ is an i-th bit of k, Zᵢ is a Pauli Z gate acting on the i-th qubit, i_{L} and j_{L} are L-th bits of i and j, and i·j=(+)_{L=1}_{^{D}}i_{L}j_{L}. Here, (×) represents a tensor product. (+) represents an exclusive OR. † represents complex conjugate transposition.

The estimation unit 3 randomly selects (i, j, i′, j′) T₂ times for each k, and calculates estimates of the real part of the values of the following expression to obtain T₂ estimates (step S3). The estimation unit 3 uniformly randomly selects (i, j, i′, j′) T₂ times for each k. The obtained T₂ estimates are sent to the average calculation unit 4. T₂ is a predetermined positive integer. Tr represents a diagonal sum.

$${( - 1 )}^{i \cdot j + {i}^{′} \cdot {j}^{′}} Tr [ {ρ}_{out} [ {Q}_{i , j}^{+} ( {\prod }_{i = 1}^{n} {z}_{i}^{{k}_{i}} ) {Q}_{{i}^{′} , {j}^{′}} ] ] \qquad [ Math . 22 ]$$

The estimation unit 3 calculates an expected value of Σ_{L}∈_{{0,1}\hat{ }3}β(i, j, i′, j′, L)/2 as an estimate of the real part of the above equation (step S3).

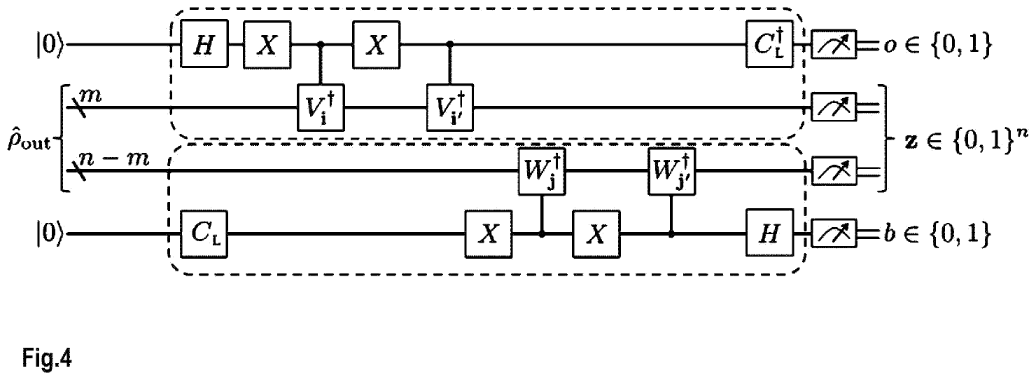

For this purpose, the estimation unit 3 operates the quantum circuit in FIG. 4 T₃ times for each L, for example. T₃ is a predetermined positive integer. H represents a Hadamard gate, and X represents a Pauli X gate. Symbols with vertical lines attached to square boxes (Vᵢ^{†}, Vᵢ,^{†}, Wⱼ^{†}, Wⱼ,^{†}) represent controlled quantum gates written in the square boxes. Further, for any L∈{0,1}³, C_{L}=S\hat{ }(δ_{L1,1}δ_{L2,0})H\hat{ }(δ_{L1+L2,1})X\hat{ }(L₃). S=√Z with Z as a Pauli Z gate. δ_{a,b} is Kronecker delta. δ_{a,b}=1 if a=b, and δ_{a,b}=0 if a≠b. The mark on the meter represents a Pauli Z measurement. o∈{0, 1}, b∈{0, 1}, and z∈{0, 1}ⁿ represent measurement results.

A part surrounded by a broken line on the upper side in FIG. 4 is referred to as a first quantum circuit. The first quantum circuit is a quantum circuit including Vᵢ that represents an m-qubit gate. Inputs of the first quantum circuit are |0> and m qubits divided by the division unit 1 in ρₒᵤₜ.

A part surrounded by a broken line on the lower side in FIG. 4 is referred to as a second quantum circuit. The second quantum circuit is a quantum circuit including Wⱼ that represents an m-qubit gate. Inputs of the second quantum circuit are |0> and n-m qubits divided by the division unit 1 in ρₒᵤₜ.

β(i, j, i′, j′, L)=(−1)^{\hat{ }}((1+δ_{L1,0}δ_{L2,0})o)α(i, j, i′, j′). It is assumed that α(i, j, i′, j′)∈{1, −1} becomes 1 only when (+)ᵢ₌₁ⁿzᵢkᵢ=i·j(+)i′·j′(+)b is satisfied and becomes −1 otherwise.

The average calculation unit 4 obtains an average of the T₂ estimates for each k, and sets the obtained average as an estimate of Tr[ρₒᵤₜ\hat{ }sₖ] corresponding to each k (step S4). The obtained estimate of Tr[ρₒᵤₜ\hat{ }sₖ] corresponding to each k is sent to the fidelity estimation value calculation unit 5.

The fidelity estimation value calculation unit 5 obtains an average of the estimate of Tr[ρₒᵤₜ\hat{ }sₖ] corresponding to each k, and sets the average as an estimate Fₑₛₜ of fidelity F of the quantum circuit U (step S5). In step S2, k is selected T₁ times. Therefore, it can also be said that the fidelity estimation value calculation unit 5 obtains an average of estimates of T₁ Tr[ρₒᵤₜ\hat{ }sₖ] and uses the average as an estimate Fₑₛₜ of the fidelity F of the quantum circuit U.

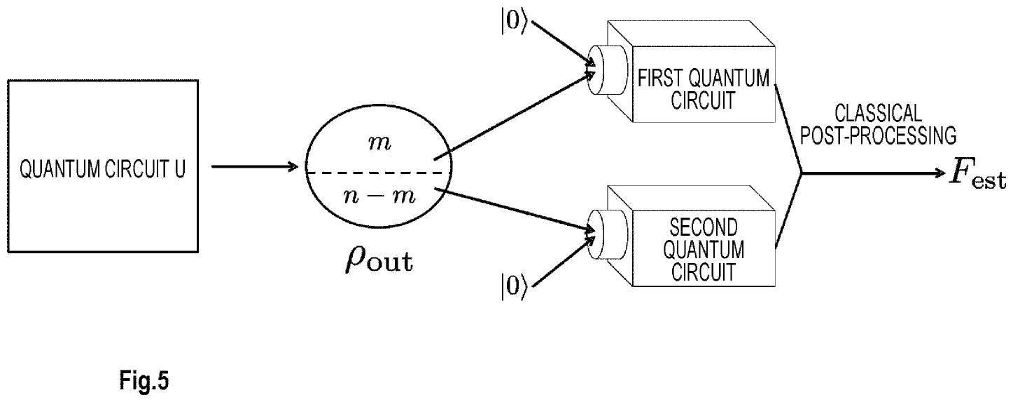

An overview of such an operation is illustrated in FIG. 5. First, the qubits of the quantum circuit U are divided into m qubits and n-m qubits. The m qubits of the output state ρₒᵤₜ of the quantum circuit U and |0> are input to the first quantum circuit. The n-m qubits of the output state ρₒᵤₜ of the quantum circuit U and |0> are input to the second quantum circuit.

In FIG. 5, calculation performed using measurement results of the first quantum circuit and the second quantum circuit is represented as classical post-processing.

Since the size of the first quantum circuit is m+1 and the size of the second quantum circuit is n−m+1, and both are less than n, the size of the quantum circuit used for verification is less than the size of the quantum computer (in this case, a NISQ computer) to be verified.

In the conventional method, it is used that fidelity to be estimated can be written by the sum of expected values of tensor products of a Pauli matrix. Therefore, a required number of copies increases exponentially with respect to the size n of the quantum computer to be verified. On the other hand, this problem is avoided by using a decomposition method different from the conventional method as in the above embodiment, for example.

The number of samples required for the method described in the embodiment is at most the value expressed as the following expression.

$$\frac{32768 {( 5 \cdot {4}^{D} + 1 )}^{6}}{{ϵ}^{6}} {( log \frac{10240 {( 5 \cdot {4}^{D} + 1 )}^{4}}{{δϵ}^{4}} )}^{3} = O ( \frac{{16}^{D}}{{ϵ}^{2}} ( D + log \frac{1}{{δϵ}^{4}} ) ) \qquad [ Math . 23 ]$$

In the case of a NISQ computer, this number is a polynomial with respect to the qubit number n because D=O(log n). In particular, in a case where D, δ, and ε are constants, the time required for verification does not change and is constant even when the size of the quantum computer increases. That is, the method described in the embodiment makes it possible to verify the NISQ computer in a shorter time than before.

The method described in the embodiment can also be applied to a case where the quantum computer to be verified is not a NISQ computer, in other words, a case where a quantum chip is not sparse although the depth is O(log n). Even in this case, the method described in the embodiment is more efficient than the conventional method. Many quantum chips currently produced can be represented by a plane graph having a constant maximum order. In the case of such representation, the dependency of the number of samples in the method described in the embodiment is 2\hat{ }(O((√n)log n)). 2\hat{ }(O((√n)log n)) is not a polynomial, but is smaller than the conventional number of samples, O(2n).

### Modified Example

While the embodiment of the present invention has been described above, specific configurations are not limited to the embodiment, and it is needless to say that appropriate design changes, and the like are included in the present invention without deviating from the gist of the present invention.

The various types of processing described in the embodiment may be performed not only in chronological order in accordance with the described order, but also in parallel or individually depending on the processing capability of a device that performs the processing or as necessary.

1. A quantum computer verification apparatus comprising processing circuitry configured to:
divide n qubits on which a quantum circuit U acts into m qubits and (n−m) qubits such that a number of CZ gates across the qubits becomes D=O(log n), the quantum circuit U being assumed to be able to be expressed by the following expression using an m-qubit gate Vᵢ and an (n−m) qubit gate Wⱼ;
$$U = \frac{1}{{2}^{D}} {\sum }_{i , j ∈ 0 , {1}^{D}} {( - 1 )}^{i \cdot j} {V}_{i} ⊗ {W}_{j} \qquad [ Math . 24 ]$$
randomly select a value of k∈{0, 1}ⁿ T₁ times, and calculate a stabilizer operator \hat{ }sₖ defined by the following expression for each k, where Q_{i,j}^{†}=Vᵢ(×)Wⱼ, kᵢ is an i-th bit of k, Zᵢ is a Pauli Z gate acting on an i-th qubit, i_{L} and j_{L} are L-th bits of i and j, i·j=(+)_{L=1}^{D}i_{L}j_{L}, and T₁ is a predetermined positive integer;
$${\hat{s}}_{k} = \frac{1}{{4}^{D}} {\sum }_{i , j , {i}^{′} , {j}^{′} ∈ {\{ 0 , 1 \}}^{D}} {( - 1 )}^{i \cdot j + {i}^{′} \cdot {j}^{′}} [ {Q}_{i , j}^{+} ( {\prod }_{i = 1}^{n} {z}_{i}^{{k}_{i}} ) {Q}_{{i}^{′} , {j}^{′}} ] \qquad [ Math . 25 ]$$
randomly select (i, j, i′, j′) T₂ times for each k and calculate estimates of a real part of a value of the following equation to obtain T₂ estimates, where ρₒᵤₜ is a state output by the quantum circuit U;
$${( - 1 )}^{i \cdot j + {i}^{′} \cdot {j}^{′}} Tr [ {ρ}_{out} [ {Q}_{i , j}^{+} ( {\prod }_{i = 1}^{n} {z}_{i}^{{k}_{i}} ) {Q}_{{i}^{′} , {j}^{′}} ] ] \qquad [ Math . 26 ]$$
obtain an average of the T₂ estimates for each k and set the obtained average as an estimate of Tr[ρₒᵤₜ\hat{ }sₖ] corresponding to each k; and
obtain an average of estimates of Tr[ρₒᵤₜ\hat{ }sₖ] corresponding to each k and set the average as an estimate Fₑₛₜ of fidelity F of the quantum circuit U.

2. A quantum computer verification method comprising:
a division step in which a division unit divides n qubits on which a quantum circuit U acts into m qubits and (n−m) qubits such that a number of CZ gates across the qubits becomes D=O(log n), the quantum circuit U being assumed to be able to be expressed by the following expression using an m-qubit gate Vᵢ and an (n−m) qubit gate Wⱼ by a stabilizer operator calculation unit;
$$U = \frac{1}{{2}^{D}} {\sum }_{i , j ∈ 0 , {1}^{D}} {( - 1 )}^{i \cdot j} {V}_{i} ⊗ {W}_{j} \qquad [ Math . 27 ]$$
a stabilizer operator calculation step in which the stabilizer operator calculation unit randomly selects a value of k∈{0, 1}ⁿT₁ times, and calculates a stabilizer operator \hat{ }sₖ defined by the following equation for each k, where Q_{i,j}^{†}=Vᵢ(×)Wⱼ, kᵢ is an i-th bit of k, Zᵢ is a Pauli Z gate acting on an i-th qubit, i_{L} and j_{L} are L-th bits of i and j, i·j=(+)_{L=1}^{D}i_{L}j_{L}, and T₁ is a predetermined positive integer;
$${\hat{s}}_{k} = \frac{1}{{4}^{D}} {\sum }_{i , j , {i}^{′} , {j}^{′} ∈ {\{ 0 , 1 \}}^{D}} {( - 1 )}^{i \cdot j + {i}^{′} \cdot {j}^{′}} [ {Q}_{i , j}^{+} ( {\prod }_{i = 1}^{n} {z}_{i}^{{k}_{i}} ) {Q}_{{i}^{′} , {j}^{′}} ] \qquad [ Math . 28 ]$$
an estimation step in which an estimation unit randomly selects (i, j, i′, j′) T₂ times for each k and calculate estimates of a real part of a value of the following equation to obtain T₂ estimates, ρₒᵤₜ being a state output by the quantum circuit U;
$${( - 1 )}^{i \cdot j + {i}^{′} \cdot {j}^{′}} Tr [ {ρ}_{out} [ {Q}_{i , j}^{+} ( {\prod }_{i = 1}^{n} {z}_{i}^{{k}_{i}} ) {Q}_{{i}^{′} , {j}^{′}} ] ] \qquad [ Math . 29 ]$$
an average calculation step in which an average calculation unit obtains an average of the T₂ estimates for each k and sets the obtained average as an estimate of Tr[ρₒᵤₜ\hat{ }sₖ] corresponding to each k; and
a fidelity estimate calculation step in which a fidelity estimate calculation unit obtains an average of estimates of Tr[ρₒᵤₜ\hat{ }sₖ] corresponding to each k and sets the average as an estimate Fₑₛₜ of fidelity F of the quantum circuit U.
